(19) United States
(12) Patent Application Publication
(10) Pub. No.: US 2024/0157876 A1
(43) Pub. Date: May 16, 2024

(54) VEHICULAR TRAILERING ASSIST SYSTEM WITH CALIBRATION BASED ON MONITORED DRIVING MANEUVERS

(71) Applicant: Magna Electronics Inc., Auburn Hills, MI (US)

(72) Inventors: Jyothi P. Gali, Rochester Hills, MI (US); Harold E. Joseph, Brampton (CA); Prasanna Ananthakrishnan, Tamilnadu (IN)

(21) Appl. No.: 18/507,626

(22) Filed: Nov. 13, 2023

Related U.S. Application Data
(60) Provisional application No. 63/383,554, filed on Nov. 14, 2022.

(51) Int. Cl. B60R 1/00

(52) U.S. Cl. CPC B60R 1/003; B60R 2300/10; B60R 2300/402; B60R 2300/80

(57) ABSTRACT

A vehicular trailering assist system includes a camera disposed at a vehicle and capturing image data representative of at least a portion of a trailer hitched to the vehicle. The vehicular trailering assist system, responsive to processing of captured image data, determines that the system has not been previously calibrated for the trailer hitched to the vehicle. The vehicular trailering assist system, responsive to determining that the system has not been previously calibrated for the trailer, determines whether a dedicated calibration maneuver is triggered. The vehicular trailering assist system, responsive to determining that the dedicated calibration of the trailer is not triggered and responsive to processing of captured image data, monitors maneuvers performed by the vehicle while the trailer is hitched to the vehicle without prompting the driver for calibration maneuvers. The vehicular trailering assist system, using the monitored maneuvers, calibrates the system for the trailer.

### CROSS REFERENCE TO RELATED APPLICATION

The present application claims the filing benefits of U.S. provisional application Ser. No. 63/383,554, filed Nov. 14, 2022, which is hereby incorporated herein by reference in its entirety.

### FIELD OF THE INVENTION

The present invention relates generally to a vehicular trailering assist system for a vehicle towing a trailer and, more particularly, to a vehicular trailering assist system that utilizes one or more cameras at a vehicle for determining trailer angle of the trailer relative to the vehicle.

### BACKGROUND OF THE INVENTION

Use of imaging sensors in vehicular trailering assist systems is common and known. Examples of such known systems are described in U.S. Pat. Nos. 9,446,713 and 9,085,261, which are hereby incorporated herein by reference in their entireties.

### SUMMARY OF THE INVENTION

A vehicular trailering assist system includes a camera disposed at a vehicle equipped with the vehicular trailering assist system that views at least rearward of the equipped vehicle and is operable to capture frames of image data. The camera includes a CMOS imaging array with at least one million photosensors arranged in rows and columns. An electronic control unit (ECU) includes electronic circuitry and associated software. Frames of image data captured by the camera are transferred to and are processed at the ECU. The vehicular trailering assist system, with a trailer hitched to the equipped vehicle and with the camera viewing at least a hitch of the trailer that hitches the trailer to the equipped vehicle, and via processing at the ECU of frames of image data captured by the camera and transferred to the ECU, determines whether the vehicular trailering assist system has been previously calibrated for the trailer hitched to the equipped vehicle. The vehicular trailering assist system, responsive to determining that the vehicular trailering assist system has not been previously calibrated for the trailer hitched to the equipped vehicle, determines whether a dedicated calibration maneuver for the vehicle has been triggered. The vehicular trailering assist system, responsive to determination that the dedicated calibration maneuver for the equipped vehicle is not triggered, and without prompting a driver of the equipped vehicle for calibration maneuvers, monitors driving maneuvers of the equipped vehicle while the trailer is hitched to the equipped vehicle. The vehicular trailering assist system is calibrated for the trailer hitched to the vehicle based on the monitored driving maneuvers of the equipped vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a trailering assist system that is operable to determine a trailer angle of a trailer relative to a towing vehicle in accordance with the present invention;

FIG. 2 is a schematic view of a calibration maneuver for calibrating a hitched trailer;

FIG. 3 is a schematic view of calibration states of the trailering assist system of FIG. 1;

FIG. 4 is a block diagram of the trailering assist system of FIG. 1;

FIG. 5 is a schematic view of sub-states of the trailering assist system of FIG. 1;

FIG. 6 are exemplary images of edge transformation;

FIG. 7 is an example image of a region of interest of an edge image;

FIG. 8 is an example image for collision angle initialization;

FIG. 9 are example images for hitch point detection;

FIG. 10 are example images of a bow transformation including a hitch point;

FIG. 11 is an image of using template matching to determine a hitch position; and

FIG. 12 is a schematic view of sub-states of a calibration state of the trailering assist system of FIG. 1.

### DESCRIPTION OF THE PREFERRED EMBODIMENTS

A vehicle and trailer maneuvering system or trailering assist system and/or driving assist system operates to capture images exterior of the vehicle and trailer being towed by the vehicle and may process the captured image data to determine a path of travel for the vehicle and trailer and to detect objects at or near the vehicle and in the predicted path of the vehicle, such as to assist a driver of the vehicle in maneuvering the vehicle and trailer in a rearward direction. The system includes an image processor or image processing system that is operable to receive image data from one or more cameras and may provide an output to a display device for displaying images representative of the captured image data. Optionally, the system may provide a rearview display or a top down or bird's eye or surround view display or the like.

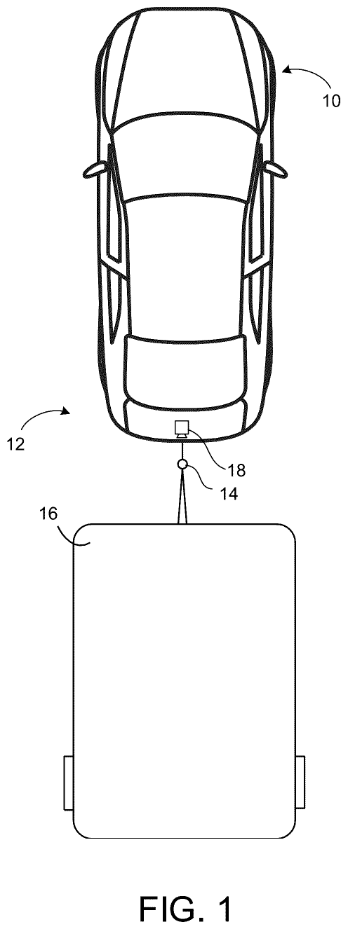

Referring now to the drawings and the illustrative embodiments depicted therein, a vehicle 10 includes a trailering assist system 12 that is operable to assist in backing up or reversing with a hitched trailer via, for example, a hitch 14 and may maneuver the vehicle 10 and trailer 16 toward a desired or selected location. The trailering assist system 12 includes at least one exterior viewing vehicle-based imaging sensor or camera, such as a rearward viewing imaging sensor or camera 18 (and the system may optionally include multiple exterior viewing imaging sensors or cameras, such as a sideward/rearward viewing camera at respective sides of the vehicle), which captures image data representative of the scene exterior of the vehicle 10, which includes the hitch 14 and/or trailer 16, with the camera 18 having a lens for focusing images at or onto an imaging array or imaging plane or imager of the camera (FIG. 1). Optionally, the camera is a center-high-mounted stop lamp (CHMSL) camera. Optionally, a forward viewing camera may be disposed at the windshield of the vehicle 10 and view through the windshield and forward of the vehicle 10, such as for a machine vision system (such as for traffic sign recognition, headlamp control, pedestrian detection, collision avoidance, lane marker detection and/or the like). The trailer maneuver assist system 12 includes a control or electronic control unit (ECU) or processor that is operable to process image data captured by the camera or cameras and may detect objects or the like and/or provide displayed images at a display device for viewing by the driver of the vehicle (the control and/or display device may be part of or incorporated in or at an interior rearview mirror assembly of the vehicle, or the control and/or the display device may be disposed elsewhere at or in the vehicle). The data transfer or signal communication from the camera to the ECU may comprise any suitable data or communication link, such as a vehicle network bus or the like of the equipped vehicle.

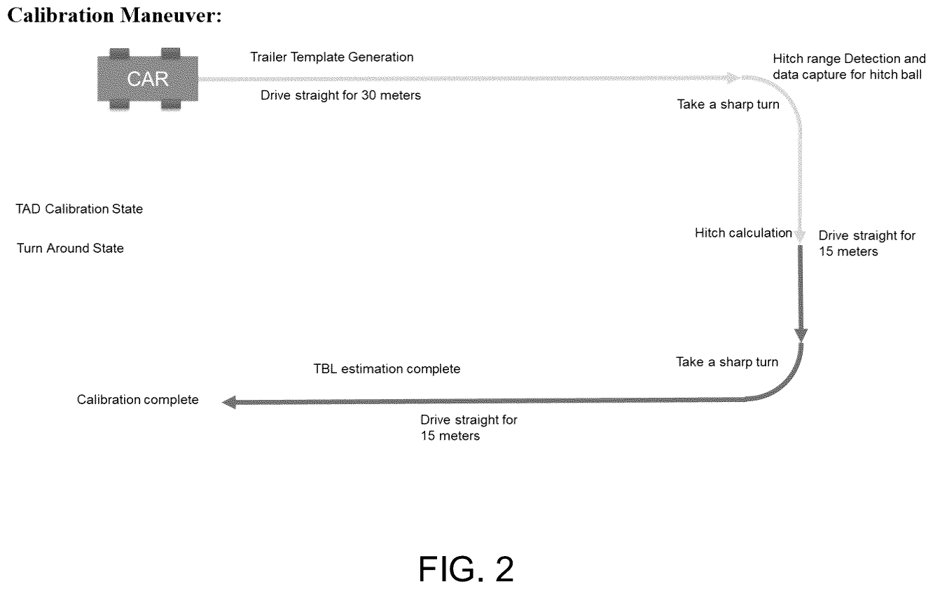

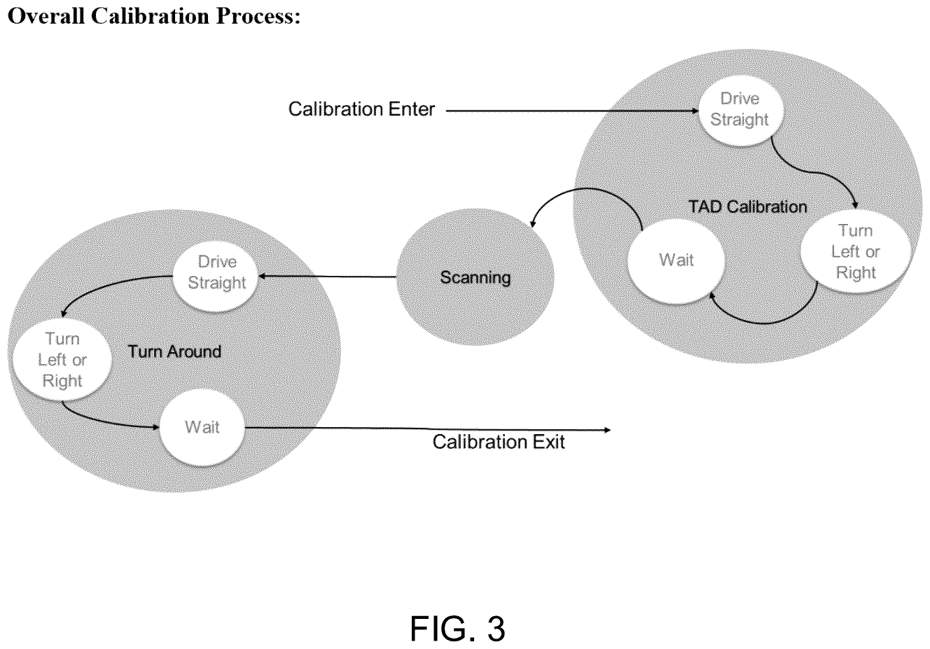

Trailer assist features are commonly included on many modern vehicles. These systems assist the driver in, for example, maneuvering with the trailer and/or warning of jackknife or other dangerous scenarios. In order to use trailer assist features, the trailer generally must first be calibrated. Calibration allows the system to accurately track the trailer angle for the hitched trailer relative to the vehicle as the vehicle and trailer move, as tracking the trailer angle using image data captured by a camera requires the system to learn or determine aspects (e.g., features) specific to the hitched trailer. As shown in FIGS. 2 and 3, calibration generally requires the driver perform a specific maneuver with the vehicle while the trailer is hitched to the vehicle to successfully calibrate the trailer to the system. The maneuver may include three states, a calibration state, a scanning state, and a turn around state. For example, the maneuver may include driving straight (i.e., with a zero or near zero degree trailer angle) for a threshold distance (e.g., at least 10 meters, at least 30 meters, at least 50 meters, etc.) and/or for a threshold period of time during a template generation period. The maneuver also generally includes a sharp turn (e.g., a ninety degree turn to the left or a ninety degree turn to the right) during a hitch range detection and hitch calculation period. The calibration may complete with another sharp turn and driving straight period. While these maneuvers may be part of a daily driving pattern for the driver, conventional systems require the maneuver to be explicitly completed by the driver in order to use trailer backup assist features. For example, conventional systems require the user to provide a user input to start the calibration process, and then the driver must perform the maneuver at that time (i.e., explicit calibration).

Implementations herein include a vehicular trailering assist system that may calibrate the trailer as a normal part of the driver's daily vehicle driving pattern (i.e., without an explicit calibration drive). Inline calibration may be triggered once the trailer is connected/hitched and calibration may then occur in the background while the driver drives naturally. For example, the system detects that a new trailer is hitched and monitors for appropriate calibration maneuvers while the driver drives the vehicle according to the driver's normal driving behaviors. This allows the user to avoid calibrating the trailer explicitly. Inline calibration may be done for target-less trailers (i.e., without a sticker, icon, or other indicia specifically identifying the trailer or portions of the trailer). Instead of inline calibration, the system may instead perform explicit calibration when instructed by the driver or when inline calibration is otherwise not feasible.

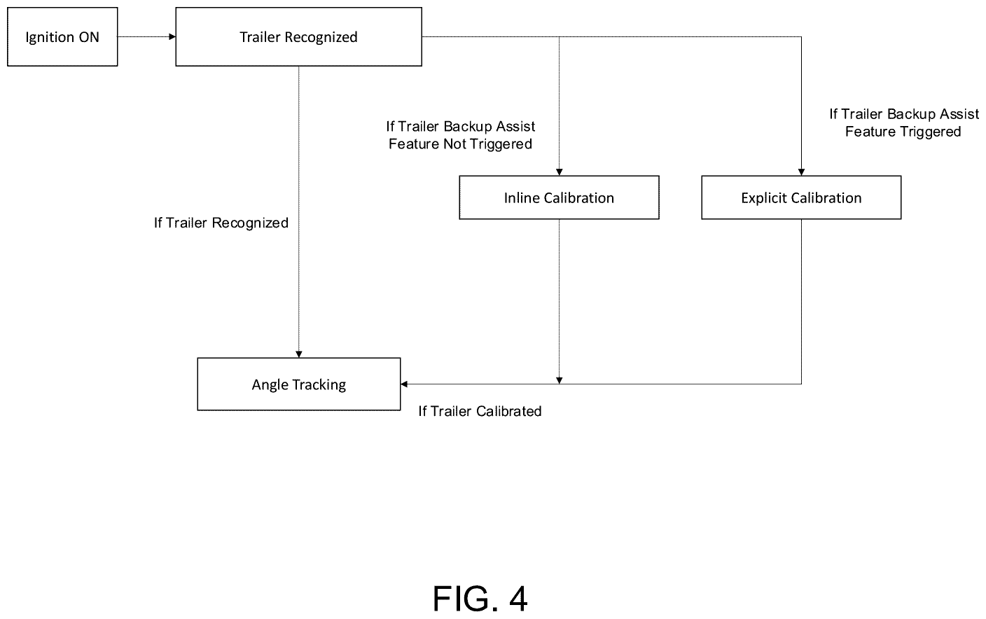

FIG. 4 includes an exemplary block diagram of the vehicular trailering assist system with inline trailer calibration. After the vehicle is started (e.g., the ignition is on), the system determines whether the hitched vehicle has already been calibrated. The system may determine that the trailer has previously been calibrated in a number of ways. For example, the user may select the trailer from a list of previously calibrated trailers. Alternatively, the system may automatically determine if the hitched trailer has been previously calibrated based on image data captured by a camera. The system may utilize aspects of trailer identification described in U.S. patent application Ser. No. 18/507,518 filed Nov. 13, 2023 (Attorney Docket MAG04 P4992), which is hereby incorporated herein by reference in its entirety.

When the system determines that hitched trailer has already been calibrated, the system retrieves the appropriate templates (i.e., the templates generated during the previous calibration) and proceeds to an angle tracking state to track, in real time, the current trailer angle of the trailer relative to the vehicle. When the system determines that the trailer has not been previously calibrated (e.g., via a user input, via processing image data captured by a camera with a field of view at least partially encompassing the hitch and/or trailer, etc.), the system determines whether to perform inline calibration or explicit calibration (i.e., require a dedicated calibration maneuver). For example, when a trailer assist feature is not triggered (i.e., the user does not perform an action triggering the use of a trailer assist feature, such as placing the vehicle in reverse or actuating a user input for a trailering feature), the system performs an inline calibration. When a trailer assist feature is triggered for use (e.g., via a user input, via placing the vehicle in reverse, etc.), the system will instead opt for explicit calibration (e.g., by requesting the driver perform the dedicated calibration maneuver). Put another way, when there is no indication that a trailer assist feature is needed, the system opts for an inline calibration. However, in the event there is an indication that a trailer assist feature is needed before inline calibration has been completed, the system may prompt the user for an explicit calibration before the trailer assist feature can be used.

When the system determines that explicit calibration is not triggered and that inline calibration is permissible, the system continuously monitors the maneuvers of the vehicle until each of a plurality of calibration maneuvers are completed. For example, the inline calibration may require the vehicle to drive straight for a threshold distance (e.g., at least 10 meters, at least 15 meters, at least 30 meters, etc.) and make a sharp turn (e.g., at least 90 degrees to the left or to the right). The system may monitor for the calibration maneuvers in any order. For example, the calibration maneuver for the sharp turn may occur before or after the drive straight calibration maneuver. Alternatively, the system may monitor for calibration maneuvers in a specific order. For example, the system may first monitor for the vehicle to drive straight for a threshold distance. Only after this portion of the calibration is complete, the system may monitor for the vehicle to perform a sharp turn. Next, the system may monitor for the vehicle to again drive straight for a threshold distance. As discussed in more detail below, whether performing explicit calibration or inline calibration, the system, via processing of image data captured by a rear viewing camera or other image sensor, calibrates the trailer (e.g., via template generation and matching) to allow for accurate tracking of the trailer angle of the trailer relative to the vehicle.

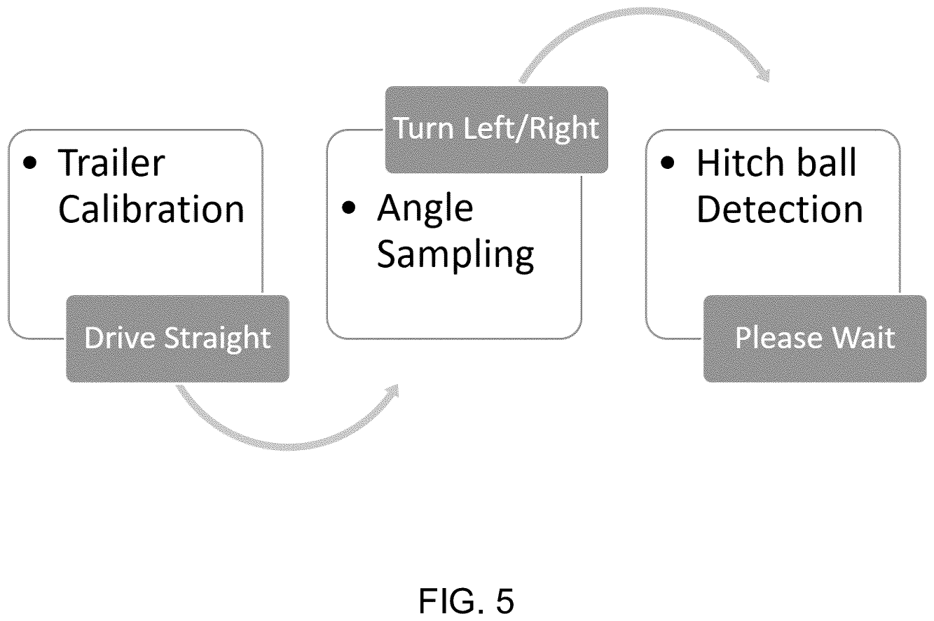

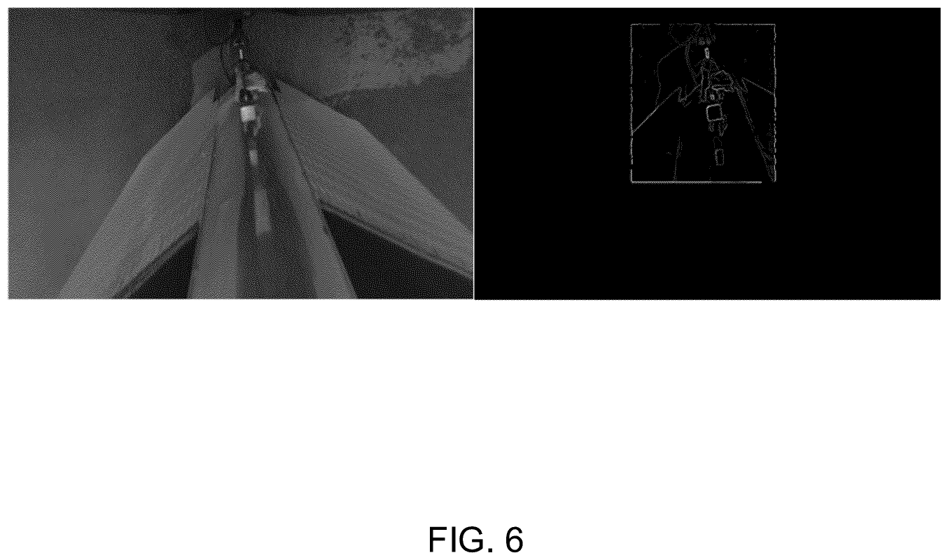

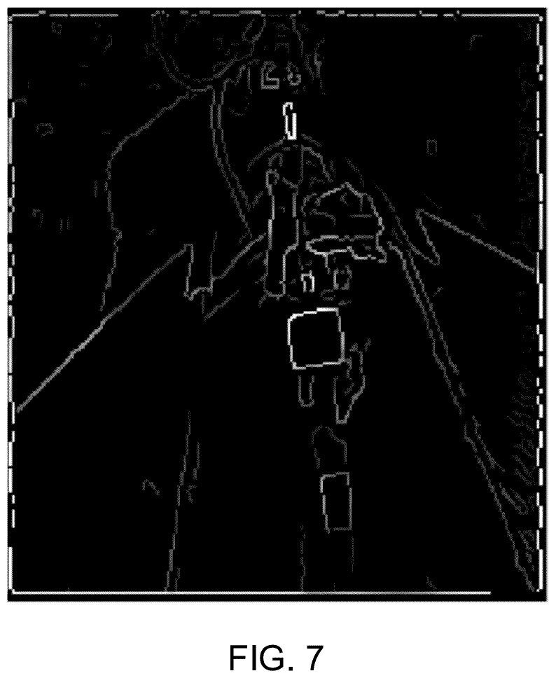

Referring now to FIG. 5, in some examples, the calibration maneuver includes three sub-states: a drive state sub-state, a turn left/right sub-state, and a please wait sub-state. In the drive straight sub-state, a kinematic model begins providing approximate trailer angles based on the current position of the steering wheel and vehicle speed. This angle is used by the system to determine whether the trailer has likely attained a zero degree trailer angle (i.e., the trailer and the vehicle are aligned). Once the trailer attains a zero degree angle (e.g., via the vehicle driving in a straight line for a sufficient distance), a trailer calibration algorithm processes the canny edges of one or more top-view images (e.g., captured by a rear-viewing camera disposed at the vehicle). The trailer calibration module may use/process an edge image. Each edge image is generated from the top view original image (FIG. 6). The top view may be transformed from the original frame of captured image data. In FIG. 6, a top-view image is illustrated on the left, while an edge image generated from the top-view image is illustrated on the right. Optionally, the system processes only a portion of the image for edge detection, as only that portion will be processed by the trailer calibration algorithm. For example, the size of the original input top view image may be 640 by 400 pixels and the region of interest (ROI) for the edge image may be 201 by 221 pixels. The trailer calibration algorithm may crop the image and process it. For example, the trailer calibration image crops the image to a size of 201 by 221 pixels (FIG. 7) or any other appropriate size based on camera resolution and system resources.

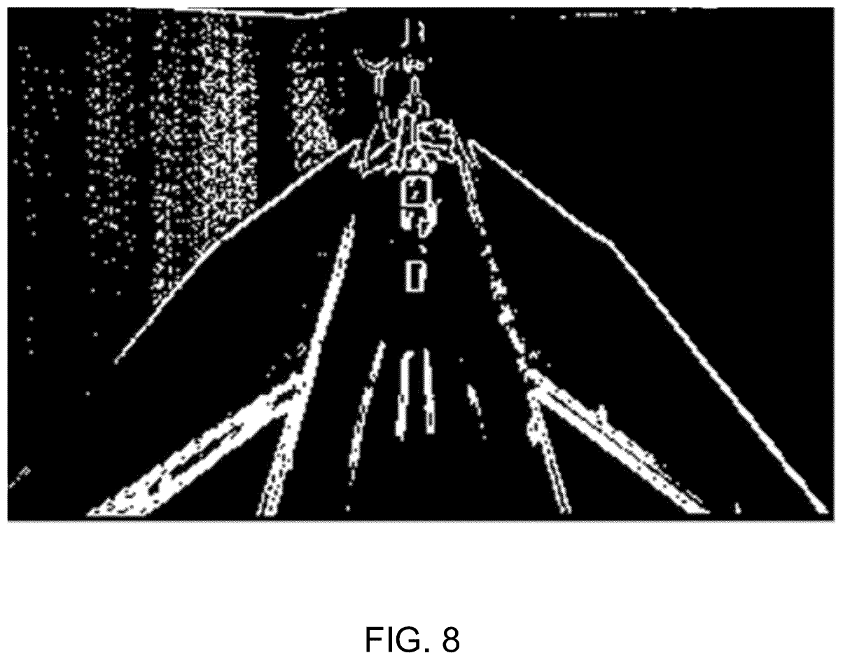

Once the trailer calibration is complete, a collision angle initialization begins. The collision angle initialization receives each edge image (e.g., with the size of 640 by 400 pixels) for, in some examples, 30 or more consecutive frames. An example input image for the collision angle initialization algorithm is shown in FIG. 8.

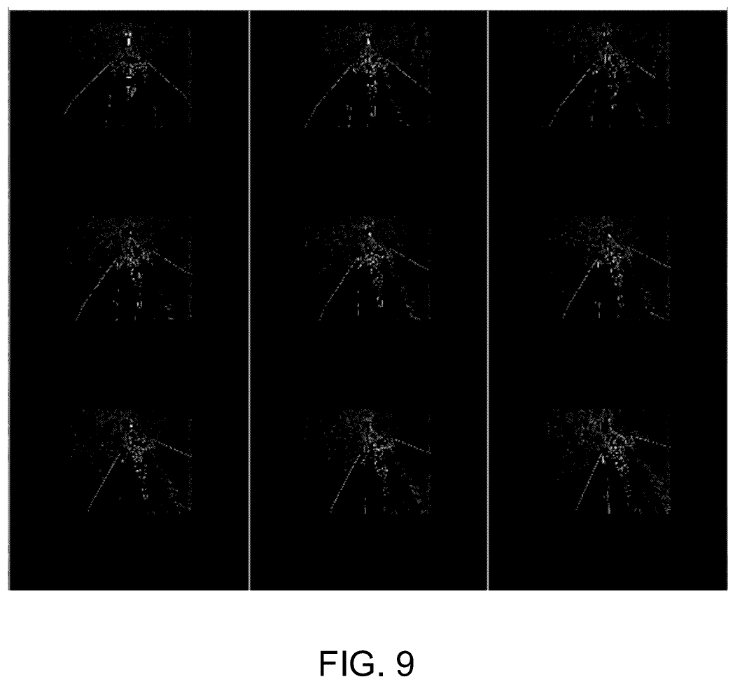

Once the calibration state enters the turn left/right sub-state, the system begins providing “dummy” angles (i.e., temporary substitute angles) with an assumed hitch point. In this sub-state, the system determines whether the hitch ball has been detected. When the hitch point is not detected, an angle sampling algorithm may execute. The angle sampling algorithm may receive/process edge top view images of the trailer and store the images. The algorithm may use the kinematic model as an angle reference. The algorithm may capture images until the trailer angle reaches a threshold trailer angle. For example, once the kinematic model reaches 25 degrees (i.e., an approximate 25 degree trailer angle relative to the vehicle), the algorithm may stop collecting images and change the state to a wait state. In this state, the collected images are used for hitch ball detection. Optionally, at least nine images are stored during the turn left/right sub-state, and each image may be captured at a different angle during the turn and updated simultaneously once it reaches 25 degrees. The size of the input image for these captured images may be 640 by 400 pixels. FIG. 9 includes an example of nine sample images that may be collected during the turn left/right sub-state as the vehicle moves through the turn.

Next, during a wait state, the dummy angle is used with the assumed hitch position. During this state, the input images from the angle sampling (FIG. 9) are used by a hitch ball detection algorithm. This algorithm may take time to process the images. For example, the algorithm may execute over many frames (e.g., 206 frames or 6.86 seconds). During this state, the system may display a wait notification to the driver. The nine input images may be processed in a sequential manner.

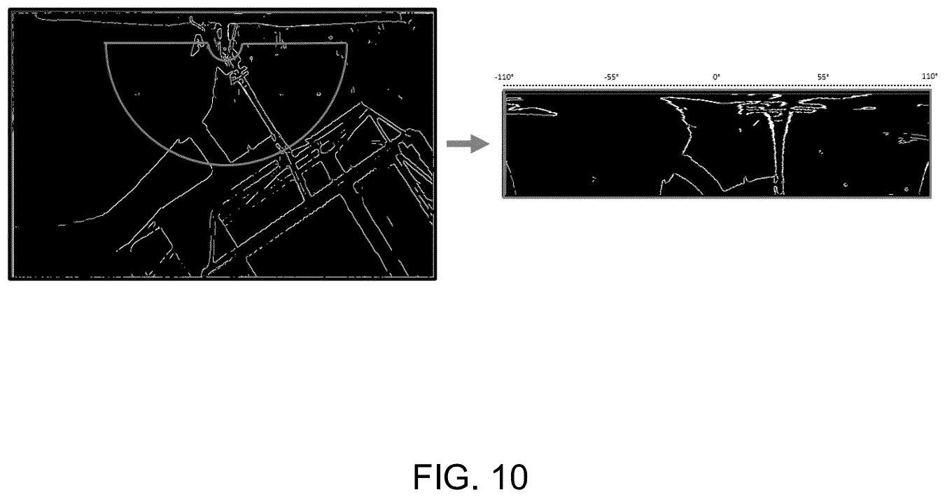

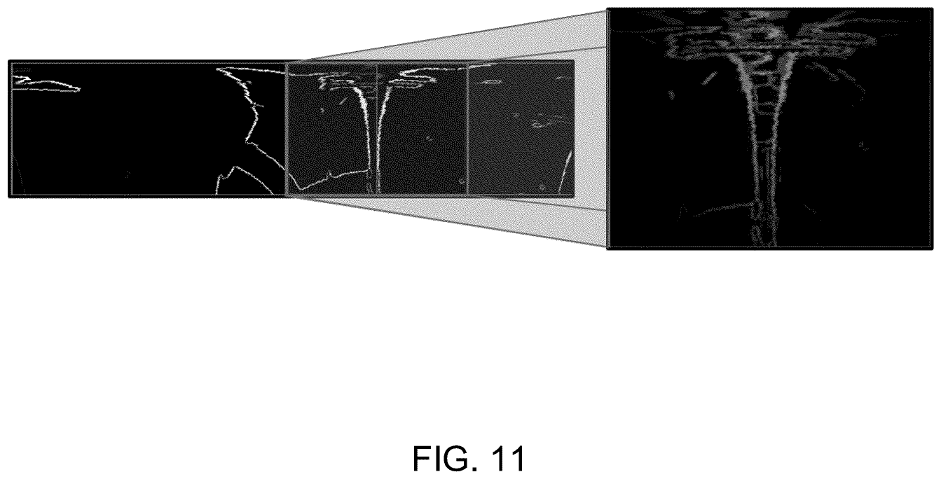

Initially, the hitch ball detection algorithm processes a single image to warp the specific ROI (FIG. 10). In the example of FIG. 10, the ROI is highlighted in the original image to the left and the warped ROI (e.g., a banana transformation or bow transformation) is shown on the right side with a size of 640 by 150 pixels. The calibration template may also be warped and cropped (e.g., to a size of 203 by 150 pixels). The algorithm may slide the trailer template over the sampled image and provide a score for each position. The best score may be selected as the trailer position. This process will run for all nine images at different warped hitch positions. The matching of the template is illustrated in FIG. 11. Once the hitch ball is located, the sub-state may change to the Turn Left/Right sub-state for collision angle detection.

During the Turn Left/Right for collision angle detection, the system determines whether the hitch ball has been detected. When the hitch ball has been detected, the system begins scanning using the newly detected hitch point with an objective of determining the exact position of the trailer (i.e., to replace the previously used dummy angle). The scanning state may run for a threshold number of frames (e.g., 15 frames, 25 frames, 50 frames, etc.) before providing the updated trailer angle. While scanning, the dummy angle may be generated with the newly detected hitch point.

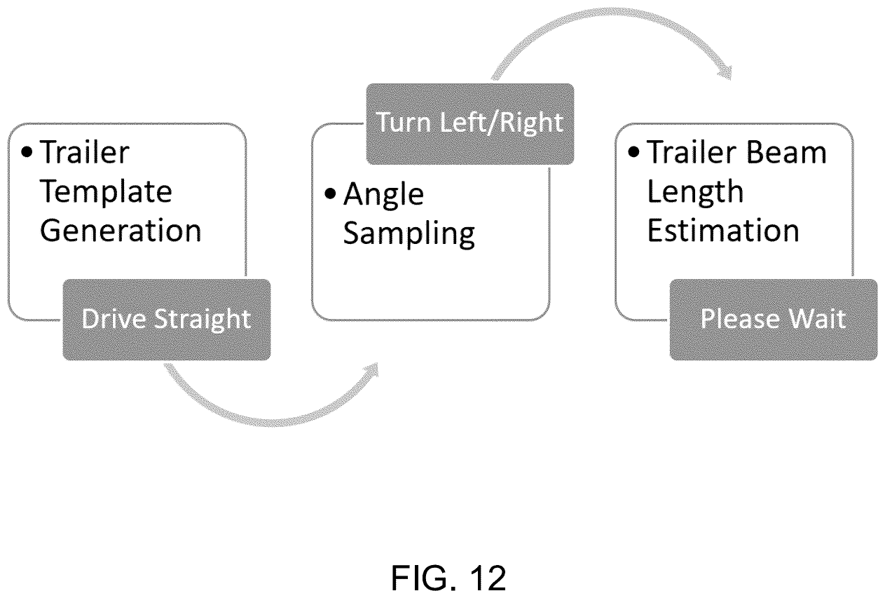

After determining the updated (and more accurate) trailer angle using the determined hitch position angle, the tracking process for this sub-state completes. After scanning, a collision angle detection algorithm may begin to execute. The collision angle detection algorithm may only begin to execute when the trailer reaches a threshold trailer angle. For example, the collision angle detection algorithm may begin processing only when the trailer reaches at least 20 degrees. After finding the collision angle, the state may be changed to the angle detection state. In the Turn Around state, the driver drives the vehicle straight for a threshold distance (e.g., at least 15 meters) and turns the vehicle left or right sharply (e.g., 90 degrees). During this state, the system may perform trailer beam length estimation (FIG. 12). These algorithms may execute partially in each of the sub-states of the Turn Around state. For example the Turn Around state includes a drive straight sub-state, a turn left/right sub-state, and a please wait sub-state.

Thus, implementations herein provide inline trailer calibration. The system determines whether a hitched trailer has been previously calibrated. When the trailer has not been previously calibrated (e.g., the trailer is hitched to the vehicle for the first time), the system determines whether inline calibration is permissible or if explicit calibration is required. For example, when there are no requests for trailer assist features (e.g., backup assistance, etc.), the system may begin inline trailer calibration. When there are requests for one or more trailer assist features (e.g., via a user input, via placing the vehicle in reverse, etc.), the system may instead prompt the user to complete explicit trailer calibration (i.e., by performing an explicit trailer calibration maneuver). The system may perform inline trailer calibration by monitoring the driver's natural driving routine as opposed to prompting for an explicit calibration maneuver. For example, the system may monitor for the driver driving the vehicle in a straight line for a threshold distance and/or for the driver to sharply turn the vehicle at least a threshold angle. During inline calibration, the system generates one or more trailer templates used by the system to accurately track the trailer angle relative to the vehicle in real-time as the vehicle maneuvers the trailer.

The system may utilize aspects of the trailering assist systems or trailer angle detection systems or trailer hitch assist systems described in U.S. Pat. Nos. 10,755,110; 10,733,757; 10,706,291; 10,638,025; 10,586,119; 10,552,976; 10,532,698; 10,160,382; 10,086,870; 9,558,409; 9,446,713; 9,085,261 and/or 6,690,268, and/or U.S. Publication Nos. US-2022-0028111; US-2022-0027644; US-2022-0024391; US-2021-0170947; US-2021-0170820; US-2021-0078634; US-2020-0406967; US-2020-0361397; US-2020-0356788; US-2020-0334475; US-2020-0017143; US-2019-0347825; US-2019-0118860; US-2019-0064831; US-2018-0276838; US-2018-0215382; US-2017-0254873; US-2017-0217372 and/or US-2015-0002670, and/or International Publication No. WO 2021/0127693, which are all hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular trailering assist system, the vehicular trailering assist system comprising:
a camera disposed at a vehicle equipped with the vehicular trailering assist system, the camera viewing at least rearward of the equipped vehicle, wherein the camera is operable to capture frames of image data;
wherein the camera comprises a CMOS imaging array, and wherein the CMOS imaging array comprises at least one million photosensors arranged in rows and columns;
an electronic control unit (ECU) comprising electronic circuitry and associated software;
wherein frames of image data captured by the camera are transferred to and are processed at the ECU;
wherein the vehicular trailering assist system, with a trailer hitched to the equipped vehicle and with the camera viewing at least a hitch of the trailer that hitches the trailer to the equipped vehicle, and via processing at the ECU of frames of image data captured by the camera and transferred to the ECU, determines whether the vehicular trailering assist system has been previously calibrated for the trailer hitched to the equipped vehicle;
wherein the vehicular trailering assist system, responsive to determining that the vehicular trailering assist system has not been previously calibrated for the trailer hitched to the equipped vehicle, determines whether a dedicated calibration maneuver for the vehicle has been triggered;
wherein the vehicular trailering assist system, responsive to determination that the dedicated calibration maneuver for the equipped vehicle is not triggered, and without prompting a driver of the equipped vehicle for calibration maneuvers, monitors driving maneuvers of the equipped vehicle while the trailer is hitched to the equipped vehicle; and
wherein the vehicular trailering assist system is calibrated for the trailer hitched to the vehicle based on the monitored driving maneuvers of the equipped vehicle.

2. The vehicular trailering assist system of claim 1, wherein the vehicular trailering assist system, responsive to determination that the dedicated calibration maneuver for the vehicle is triggered, prompts the driver to perform the dedicated calibration maneuver.

3. The vehicular trailering assist system of claim 2, wherein the vehicular trailering assist system is calibrated responsive at least in part to processing at the ECU of image data captured by the camera during the dedicated calibration maneuver.

4. The vehicular trailering assist system of claim 1, wherein the dedicated calibration maneuver for the equipped vehicle is triggered at least in part responsive to the equipped vehicle being in a reverse propulsion mode.

5. The vehicular trailering assist system of claim 1, wherein the dedicated calibration maneuver for the equipped vehicle is triggered at least in part responsive to actuation of a user input associated with a trailer assist feature.

6. The vehicular trailering assist system of claim 1, wherein the vehicular trailering assist system monitors the driving maneuvers of the equipped vehicle until the equipped vehicle performs a plurality of target driving maneuvers.

7. The vehicular trailering assist system of claim 6, wherein the plurality of target driving maneuvers comprises (i) a drive straight for a threshold distance portion and (ii) a sharp turn portion.

8. The vehicular trailering assist system of claim 7, wherein the sharp turn portion comprises a 90 degree turn.

9. The vehicular trailering assist system of claim 7, wherein the drive straight for the threshold distance portion comprises driving the equipped vehicle in a straight line for at least fifteen meters.

10. The vehicular trailering assist system of claim 1, wherein, with the vehicular trailering assist system calibrated, the vehicular trailering assist system tracks a trailer angle of the trailer relative to the equipped vehicle.

11. The vehicular trailering assist system of claim 1, wherein the vehicular trailering assist system is calibrated at least in part by generating a trailer template specific to the trailer hitched to the equipped vehicle.

12. The vehicular trailering assist system of claim 1, wherein the vehicular trailering assist system determines whether the vehicular trailering assist system has been previously calibrated for the trailer hitched to the equipped vehicle at least in part based on processing at the ECU of frames of image data captured by the camera and transferred to the ECU.

13. The vehicular trailering assist system of claim 1, wherein the vehicular trailering assist system monitors driving maneuvers of the equipped vehicle while the trailer is hitched to the equipped vehicle at least in part via processing at the ECU of frames of image data captured by the camera and transferred to the ECU.

14. A vehicular trailering assist system, the vehicular trailering assist system comprising:
a camera disposed at a vehicle equipped with the vehicular trailering assist system, the camera viewing at least rearward of the equipped vehicle, wherein the camera is operable to capture frames of image data;
wherein the camera comprises a CMOS imaging array, and wherein the CMOS imaging array comprises at least one million photosensors arranged in rows and columns;
an electronic control unit (ECU) comprising electronic circuitry and associated software;
wherein frames of image data captured by the camera are transferred to and are processed at the ECU;
wherein the vehicular trailering assist system, with a trailer hitched to the equipped vehicle and with the camera viewing at least a hitch of the trailer that hitches the trailer to the equipped vehicle, and via processing at the ECU of frames of image data captured by the camera and transferred to the ECU, determines whether the vehicular trailering assist system has been previously calibrated for the trailer hitched to the equipped vehicle;
wherein the vehicular trailering assist system, responsive to determining that the vehicular trailering assist system has not been previously calibrated for the trailer hitched to the equipped vehicle, determines whether a dedicated calibration maneuver for the equipped vehicle has been triggered, and wherein the dedicated calibration maneuver for the equipped vehicle is triggered at least in part responsive to at least one selected from the group consisting of (i) the equipped vehicle being in a reverse propulsion mode and (ii) actuation of a user input associated with a trailer assist feature;
wherein the vehicular trailering assist system, responsive to determination that the dedicated calibration maneuver for the equipped vehicle is not triggered, and without prompting a driver of the equipped vehicle for calibration maneuvers, monitors driving maneuvers of the equipped vehicle while the trailer is hitched to the equipped vehicle;
wherein the vehicular trailering assist system is calibrated for the trailer hitched to the equipped vehicle based on the monitored driving maneuvers of the equipped vehicle; and
wherein, with the vehicular trailering assist system calibrated, the vehicular trailering assist system tracks a trailer angle of the trailer relative to the equipped vehicle.

15. The vehicular trailering assist system of claim 14, wherein the vehicular trailering assist system monitors the driving maneuvers of the equipped vehicle until the equipped vehicle performs a plurality of target driving maneuvers.

16. The vehicular trailering assist system of claim 15, wherein the plurality of target driving maneuvers comprises (i) a drive straight for a threshold distance portion and (ii) a sharp turn portion.

17. The vehicular trailering assist system of claim 16, wherein the sharp turn portion comprises a 90 degree turn.

18. The vehicular trailering assist system of claim 16, wherein the drive straight for the threshold distance portion comprises driving the equipped vehicle in a straight line for at least fifteen meters.

19. A vehicular trailering assist system, the vehicular trailering assist system comprising:
a camera disposed at a vehicle equipped with the vehicular trailering assist system, the camera viewing at least rearward of the equipped vehicle, wherein the camera is operable to capture frames of image data;
wherein the camera comprises a CMOS imaging array, and wherein the CMOS imaging array comprises at least one million photosensors arranged in rows and columns;
an electronic control unit (ECU) comprising electronic circuitry and associated software;
wherein frames of image data captured by the camera are transferred to and are processed at the ECU;
wherein the vehicular trailering assist system, with a trailer hitched to the equipped vehicle and with the camera viewing at least a hitch of the trailer that hitches the trailer to the equipped vehicle, and via processing at the ECU of frames of image data captured by the camera and transferred to the ECU, determines whether the vehicular trailering assist system has been previously calibrated for the trailer hitched to the equipped vehicle;
wherein the vehicular trailering assist system, responsive to determining that the vehicular trailering assist system has not been previously calibrated for the trailer hitched to the equipped vehicle, determines whether a dedicated calibration maneuver for the equipped vehicle has been triggered;
wherein the vehicular trailering assist system, responsive to determination that the dedicated calibration maneuver for the equipped vehicle is not triggered, and without prompting a driver of the equipped vehicle for calibration maneuvers, monitors driving maneuvers of the equipped vehicle while the trailer is hitched to the equipped vehicle, and wherein the vehicular trailering assist system monitors the driving maneuvers of the equipped vehicle until the equipped vehicle performs a plurality of target driving maneuvers;
wherein the vehicular trailering assist system, responsive to determination that the dedicated calibration maneuver for the equipped vehicle is triggered, prompts the driver to perform the dedicated calibration maneuver; and
wherein the vehicular trailering assist system is calibrated for the trailer hitched to the equipped vehicle based on one selected from the group consisting of (i) the monitored driving maneuvers of the equipped vehicle and (ii) the dedicated calibration maneuver.

20. The vehicular trailering assist system of claim 19, wherein the plurality of target driving maneuvers comprises (i) a drive straight for a threshold distance portion and (ii) a sharp turn portion.

21. The vehicular trailering assist system of claim 20, wherein the sharp turn portion comprises a 90 degree turn.

22. The vehicular trailering assist system of claim 20, wherein the drive straight for the threshold distance portion comprises driving the equipped vehicle in a straight line for at least fifteen meters.
